(19) United States
(12) Patent Application Publication
(10) Pub. No.: US 2025/0225495 A1
(43) Pub. Date: Jul. 10, 2025

(54) SYSTEMS AND METHODS FOR A ROOT CAUSE SMART ASSISTANT

(71) Applicant: Wells Fargo Bank, N.A., San Francisco, CA (US)

(72) Inventors: Miriam F. Clark, San Francisco, CA (US); Sadie S. Salim, Mill Valley, CA (US); Dennis E. Montenegro, Concord, CA (US)

(21) Appl. No.: 18/153,218

(22) Filed: Jan. 11, 2023

(51) Int. Cl. G06Q 20/14; G06F 16/903

(52) U.S. Cl. CPC G06Q 20/14; G06F 16/90335

(57) ABSTRACT

Systems and methods for assisting users in answering questions about transactions and providing explanations for processing of transactions. about products and services One disclosed system includes a processor and memory with stored instructions which when executed by the processor cause the processor to: receiving from a first user an explanation request associated with a current transaction; determining characteristics of the current transaction based in part on data associated with current transaction; generating a first graph based on the current transaction data; generating a second graph based on historical transaction data; comparing the first graph and second graph to identify differences between the first graph and the second graph; determining one or more causes of the differences between the first graph and the second graph based on machine learning; determining a textual description of the causes; and outputting the textual description to a display device viewable by the first user.

### FIELD OF INVENTION

The present disclosure generally relates to artificial intelligence and machine learning chatbots, and more particularly to systems and methods for using artificial intelligence and machine learning to generate textual explanations to user questions.

### BACKGROUND

Companies often rely on chatbots to reduce the need for customer service representatives. Chatbots are a useful tool for companies because they may service a high volume of customers simultaneously, and without the need for customers to wait in a long queue. Chatbots also may help customers outside of normal business hours and may aid customers in various languages without needing a translator. However, current chatbots are ill-suited to provide answers and explanations of actions taken by companies, such as explaining why a charge was made to a customer's account or explaining how a transaction was processed by the company. Current chatbots also don't use data of users to learn the habits and actions of users, rather current chatbots generally provide canned responses to user questions without additional analysis to check whether the canned response is applicable to a user's situation.

### SUMMARY

According to certain embodiments, a method for a root cause smart assistant comprises: receiving from a first user an explanation request associated with a current transaction; determining characteristics of the current transaction based in part on data associated with the current transaction; generating a first graph based on the current transaction data; generating a second graph based on historical transaction data; comparing the first graph and second graph to identify differences between the first graph and the second graph; determining one or more causes of the differences between the first graph and the second graph based on machine learning; determining a textual description of the causes; and outputting the textual description to a display device viewable by the first user. According to further embodiments, the method for a root cause smart assistant may further comprise: generating a diagram based on the textual description, wherein the diagram conveys steps taken by the machine learning in determining the causes of the differences between the first graph and the second graph; requesting additional information associated with the current transaction; receiving additional information, wherein the additional information is used in determining one or more causes of the differences between the first graph and the second graph; generating a user profile based on the historical transaction data; determining based on the user profile, an irregularity in the current transaction; notifying the user of the irregularity; processing the current transaction according to past transactions of the user; determining the current transaction is a loan payment; and determining to apply the loan payment to an outstanding balance, to a loan principal, or to loan interest.

According to another embodiment, a non-transitory computer readable medium may comprise program code, which when executed by one or more processors, causes the one or more processors to: receive from a first user an explanation request associated with a current transaction; determine characteristics of the current transaction based in part on data associated with current transaction; generate a first graph based on the current transaction data; generate a second graph based on historical transaction data; compare the first graph and second graph to identify differences between the first graph and the second graph; determine one or more causes of the differences between the first graph and the second graph based on machine learning; determine a textual description of the causes; and output the textual description to a display device viewable by the first user.

According to another embodiment, a system for a root cause smart assistant may comprise: one or more processors; and memory that stores instructions that, when executed by the one or more processors, cause the one or more processors to: receive from a first user an explanation request associated with a current transaction; determining characteristics of the current transaction based in part on data associated with current transaction; generate a first graph based on the current transaction data; generate a second graph based on historical transaction data; compare the first graph and second graph to identify differences between the first graph and the second graph; determine one or more causes of the differences between the first graph and the second graph based on machine learning; determine a textual description of the causes; and output the textual description to a display device viewable by the first user.

### BRIEF DESCRIPTION OF THE DRAWINGS

A full and enabling disclosure is set forth more particularly in the remainder of the specification. The specification makes reference to the following appended figures.

FIG. 1 illustrates an exemplary root cause smart assistant system communicating between a user device and an application running on cloud service provider (CSP) infrastructure.

FIG. 2 illustrates an exemplary root cause smart assistant user interface running on a web browser.

FIG. 3 illustrates a flow chart for a method of operating a root cause smart assistant, particularly illustrating how the root cause smart assistant determines textual descriptions.

FIG. 4A and FIG. 4B illustrates a graphical representation of a current transaction and historical transaction, respectively, generated by machine learning and artificial intelligence techniques.

### DETAILED DESCRIPTION

Reference will now be made in detail to various and alternative illustrative examples and to the accompanying drawings. Each example is provided by way of explanation, and not as a limitation. It will be apparent to those skilled in the art that modifications and variations can be made. For instance, features illustrated or described as part of one example may be used on another example to yield a still further example. Thus, it is intended that this disclosure include modifications and variations as come within the scope of the appended claims and their equivalents.

### Illustrative Examples of a Root Cause Smart Assistant

In one illustrative embodiment, a root cause smart assistant comprises an application for generating textual descriptions including answers and explanations to user questions about processed transactions and other actions taken by the company, such as changes made to a user account, charging late fees, delays in transaction processing, and changes in services. The application may use data from past interactions with users or transactions to provide more accurate explanations to user questions. In some examples, the application may also use data from past interactions or past transactions to correct or prevent issues for users, such as by adjusting processing of payments or notifying a user that the user's actions are different from the user's routine. The application receives input from a user, such as a question, through a user interface (e.g., the question may be typed or received via audio and converted using voice to text). The application uses Natural Language Processing (NLP) to identify a current transaction or action by the company associated with the user's question. For example, the user may ask “Why was my mortgage payment not applied to next month's payment?” The application may use Natural Language Processing to identify terms such as “mortgage payment” and “not applied” to determine that the user is referencing an issue with processing the user's mortgage payments. In some examples, the application may identify that additional information is needed from the user, and may ask additional questions of the user. For example, if the user has multiple mortgages, the application may ask the user which mortgage the user is referencing.

The application determines further characteristics of the current transaction from data associated with the current transaction. The application may determine characteristics such as date and time when the transaction occurred, the monetary value of the transaction, the purpose of the transaction, the accounts involved in the transaction, the transactors or parties of the transaction, and actions taken by the company to process the current transaction. For example, the application may determine characteristics of the current transaction based on tags applied by the company associated with the current transaction data. In further examples, the company may automatically apply tags to the current transaction data indicating characteristics of the current transaction. The tags may also include explanations of actions taken by a company in processing the current transaction. For example, the company may store information about processing procedures, contract terms for users such as terms of a mortgage, and service agreements in a repository, and the company may automatically apply a tag associated with the stored information to data when processing the transaction. For example, a company may have processing procedures in which the company applies a late fee to payments made more than three days after a due date. In such an example, the company may tag late fees with a textual explanation of the processing procedure.

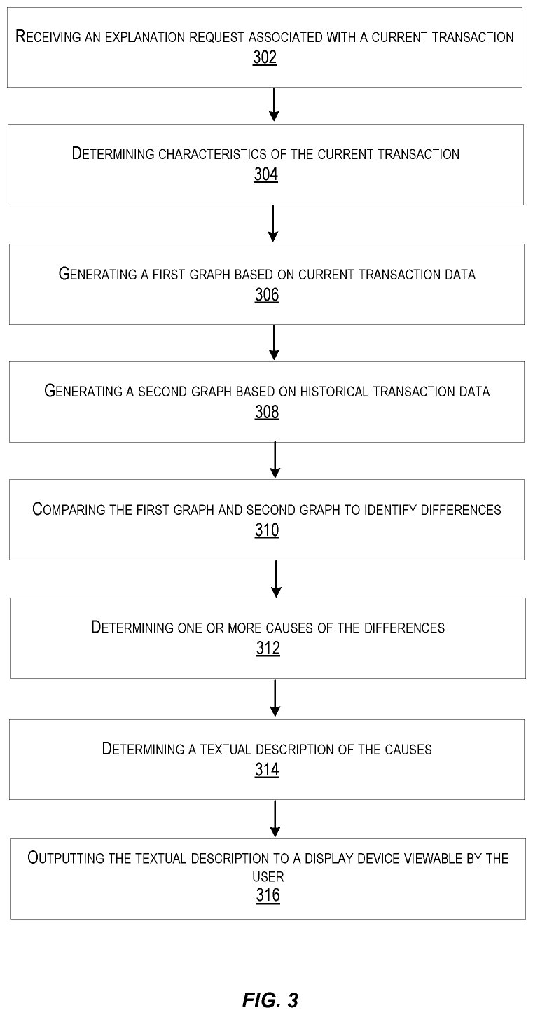

The application may query a database or repository for historical transaction data sharing characteristics of the current transaction data, such as past transactions by the user. In some examples, the application may query the database or repository based on shared tags between the historical transaction data and the current transaction data. In further examples, the historical transaction data is associated with the user asking the question, such as historical transaction data of the user's prior transactions. In other examples, the application may aggregate historical transaction data from multiple users. Based on the characteristics of the current transaction data and historical transaction data, the application uses various machine learning and artificial intelligence techniques to generate graphs associated with the current transaction data, and historical transaction data of users. The machine learning and artificial intelligence techniques are described further in the description of FIG. 3. The application compares the graphs of the current transaction data and historical transaction data to determine an answer to the user's question. The graphs convey connections between characteristics of the current transaction and historical transactions. The graphs may convey connections between characteristics of the transactions by linking characteristics to other characteristics and linking characteristics to an effect such as an action taken by the company when processing the current transaction. In some examples, the application may use pattern recognition to link characteristics. For example, the application may link a characteristic, such as time and date of a credit card payment, with an effect such as a late fee because late fees follow late credit card payments on user accounts.

The application compares the first graph and the second graph to identify differences between the first graph and the second graph. For example, the application may compare the linked characteristics of the graphs to identify missing characteristics and to deduce why the effect is the same or different for the current transaction data and historical transaction data. When the comparison requires further information to identify differences between the first and second graph, the application may also set up agents to establish and activate API calls, screen scrape information by extracting readable information from websites, and monitor written and visual data sources for more information. In some embodiments, for example, this additional information may comprise additional information related to transaction processing procedures of a company. The application may use the further information from the agents to fill in gaps in information, when the comparison of current transaction data and historical transaction data is insufficient to provide an answer for differences in transaction processing.

The application may use Natural Language Processing (NLP) to generate textual descriptions of the transaction and may output the textual descriptions to a display for viewing by a user. Users may select the textual descriptions on a user interface and request further information. The application may output a diagram conveying the actions executed by the application when determining the differences between the current transaction data and the historical transaction data. For example, when the application screen scrapes information from the transaction log, the application may generate and store a textual description of the screen scrape by the application and display the textual description when prompted by a user. Users may provide feedback to the application on the helpfulness of the textual descriptions, which the application may use to update templates and future textual descriptions.

### A Root Cause Smart Assistant System

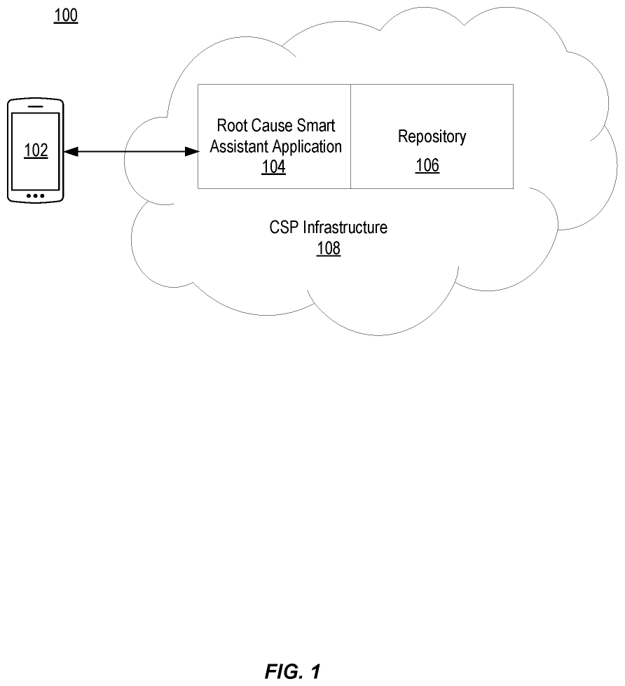

FIG. 1 illustrates a root cause smart assistant system 100. The root cause smart assistant system includes an application 104; one or more user devices 102 such as a smartphone, laptop, or tablet; a repository 106; and cloud service provider (CSP) infrastructure 108, such as various servers, computing devices, processors, and databases.

As shown in FIG. 1, the application 104 may run on the cloud service provider (CSP) infrastructure 108. In other embodiments, the user device 102 may execute the application 104. Users may interact with the application 104 through a user interface such as a guided user interface (GUI) on a browser or application running locally on the user device 102.

Users input questions and explanation requests into the application 104 by input fields of a user interface. The application 104 uses Natural Language Processing (NLP) to extract information from user inputs. Based on the user input, the application 104 queries the repository 106 for current transaction data and historical transaction data.

The application 104 may download from and upload data to repository 106. The repository 106 may run on cloud service provider (CSP) infrastructure and comprise various servers and databases to store information associated with user transactions, such as historical transaction data of users and current transaction data. Historical transaction data may include past transactions and other actions by users such as past mortgage payments, past credit card payments, past transfers of money, and past loan applications. In some examples, repository 106 may store user profiles, which may comprise collections of historical transaction data associated with the user. The repository 106 may also store further information such as shell templates for explanations to questions, past answers for questions, and feedback from users on answers and explanations. For example, the repository may include a user profile for a user which includes historical data such as the mortgage payments, credit card payments, and money transfers of the user. The application 104 may query the repository 106 for a user profile and historical transaction data from users.

### Illustrative Example of a Root Cause Smart Assistant on a Web Browser

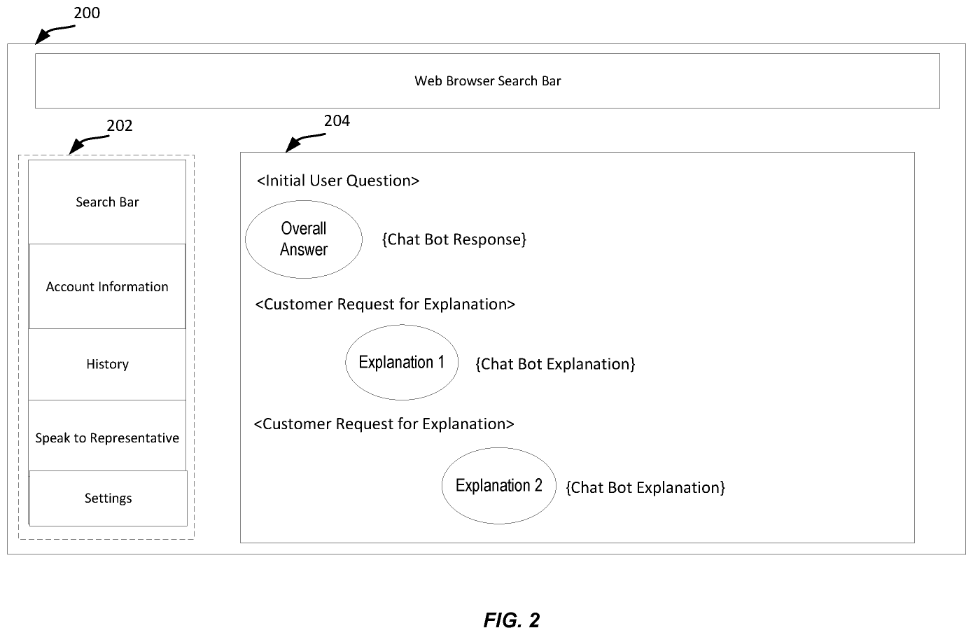

FIG. 2 illustrates an exemplary user interface 200 run on a web browser. The user interface may include various input fields and tabs 202. Users may provide input to the input fields and tabs 202 to search for account history, input questions, and explanation requests. By way of example, the user interface may include a search bar, a tab for user account information, a tab of transaction history for the user, a tab to transfer a user to a human customer service representative, and a settings tab.

The user interface 200 includes an explanation area 204, which provides users with textual descriptions of issues with a transaction faced by a user, textual explanations of causes of the user's issue, and textual answers to user questions. Users enter a question into an input field of the user interface and the application conveys an answer to the question in the explanation area 204. Users may provide input to the explanation area 204, such as inputting requests for additional explanation. The application then generates additional textual descriptions to answer the user requests for additional explanation. In some examples, the application may automatically generate a tree diagram (not shown) in the explanation area 204 that displays actions taken by the application in determining an answer to the user question and questions generated by the application answered by the user or the application. Users may select portions of the tree diagram provided in the explanation area 204 for further detail. When users select a portion of the tree diagram, the explanation area 204 may convey a textual description of the logic or action taken by the application in determining the answer to the question. For example, the application may populate a tree diagram with questions generated by the application and actions taken by the application in determining why a mortgage payment was applied to the principal of the loan and not the next month's loan payment. The application may generate the tree diagram when a user asks a question such as “why does my account display an outstanding balance for my mortgage payment”, “why is my credit card balance greater than the sum of my transactions”, and “why did I get a late payment notice.” The application may populate the tree diagram with textual descriptions of determinations from the machine learning and artificial intelligence techniques further described in FIG. 3. In some examples, the branches of the tree diagram may represent “why” questions asked by the application, and the textual descriptions may represent answers to the “why” questions.

### Illustrative Methods of Operating a Root Cause Smart Assistant

FIG. 3 is a flowchart showing illustrative method 300 for operating a root cause smart assistant. In some examples, some of the steps in the flow chart of FIG. 3 are implemented in program code executed by a processor, for example, the processor in a general-purpose computer, mobile device, or server. In some examples, these steps are implemented by a group of processors. In some examples the steps shown in FIG. 3 are performed in a different order or one or more steps may be skipped. Alternatively, in some examples, additional steps not shown in FIG. 3 may be performed.

At block 302 the method 300 receives an explanation request associated with a current transaction. A user may input the explanation request into a user interface of the root cause smart assistant, such as by typing a question into an input field. In some examples, the explanation requests are requests for explanation of issues faced by the user, such as explanations for why a company fined a user for a late payment, or why a company locked a user out of a service.

At block 304, the method 300 determines characteristics of the current transaction. For example, the application may determine characteristics based on tags associated with data representing the current transaction. The current transaction data may include tags, such as metadata, describing characteristics of the current transaction data. The tags may include various characteristics of the current transaction such as: date and time when the transaction occurred, the monetary value of the transaction, the purpose of the transaction, the accounts involved in the transaction, and actions taken by a company in processing the current transaction. In other examples, the application may screen scrape information from a transaction log to determine information associated with the transaction. For example, the application may screen scrape information from a webpage of the user's account and use Natural Language Processing (NLP) to determine characteristics of the current transaction from the screen scraped information. In other examples, the application may receive information associated with the current transaction from a repository or database of user transactions. In further examples, the application may call APIs and conduct searches of a database to identify characteristics of transactions. For example, the application may call an API of a mobile banking application to determine time and date of a user's payment.

At block 306, the method 300 generates a first graph based on current transaction data. The first graph may include nodes representing characteristics of the current transaction data. The application may link characteristics of the current transaction data to other characteristics and actions taken by the company when processing the current transaction using pattern recognition techniques such as correlation clustering and K-means clustering. For example, the company may use training data to train the application to identify connections between characteristics. For example, a current transaction may be an early mortgage payment that a company applied to the mortgage loan principal instead of applied to the next month's payment. The application may identify characteristics from the current transaction such as that the mortgage payment was paid on the first of the month, and that the mortgage payment was applied to the mortgage principal instead of the next month's payment and link the date of payment to payments on mortgage principal.

At block 308, the method 300 generates a second graph based on historical transaction data. The second graph may include nodes representing characteristics of historical transaction data. The historical transaction data may be historical transaction data of a particular user, or may be an aggregation of historical transaction data from multiple users. The historical transaction data may include characteristics such as the date and time when the transaction occurred, the monetary value of the transaction, the purpose of the transaction, the accounts involved in the transaction, and actions taken by a company in processing the historical transaction.

At block 310, the method 300 compares the first graph and the second graph to identify differences in the current transaction data and the historical transaction data. For example, the application may compare the characteristics of the current transaction and historical transaction conveyed on the graph by identifying differences in the connections between characteristics and the actions taken by the company. The application may enter characteristics and connections between characteristics of the first graph and second graph into an algorithm to identify differences between the first and second graph. For example, the algorithm may identify that the first graph links a characteristic, such as a date of payment, to charging a late fee whereas the second graph links a characteristic, such as a different date of payment, to an indication of an on-time payment.

At block 312, the method 300 determines one or more causes of the differences between the first graph and the second graph. The application may determine one or more causes of the differences between the first graph and the second graph using machine learning and artificial intelligence techniques. For example, the application may use various machine learning techniques such as neural networks, trained and untrained classifiers, support-vector machines, decision trees, and Bayesian networks to determine one or more causes of the differences. In one example, the application may determine the causes of the differences by setting up agents to conduct searches of databases of company procedures, and service agreements associated with the differences to determine one or more causes of the company's action.

At block 314, the method 300 determines a textual description of the causes. In some examples, the application may populate a shell description with information from the current transaction and historical transaction. In other examples, the application may determine the textual description using Natural Language Generation (NLG) techniques to generate a textual description based on the determined cause of the differences between the first graph and the second graph.

At block 316, the method 300 outputs the textual description to a display device viewable by the user.

### Illustrative Example of Root Cause Smart Assistant Artificial Intelligence

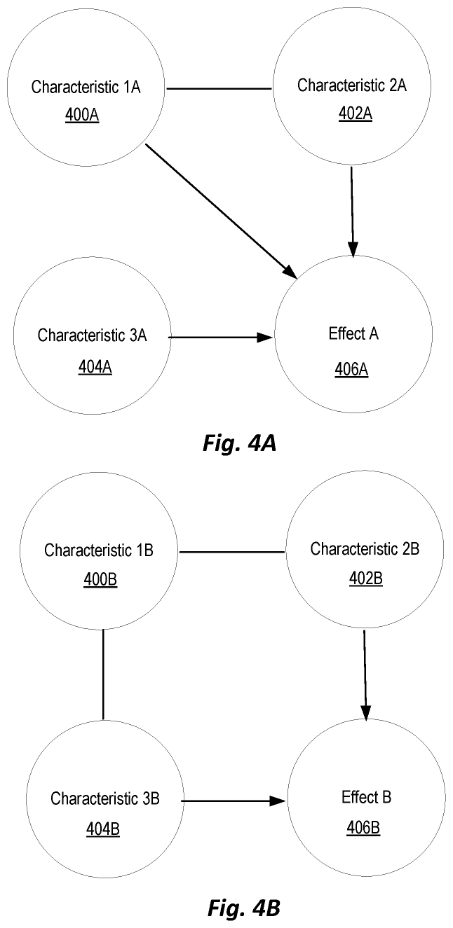

FIG. 4A and FIG. 4B illustrate graphical representations of a current transaction and historical transaction, respectively, generated by machine learning and artificial intelligence techniques.

FIG. 4A illustrates an exemplary graph of linked characteristics of current transaction data. By way of example, FIG. 4A includes characteristic 1A 400A, characteristic 2A 402A, and characteristic 3A 404A. The characteristics 400A 402A 404A may represent various characteristics of the current transaction data such as date and time of the transaction, the monetary value of the transaction, and the parties to the transaction. The root cause smart assistant application links characteristics 1A, 2A and 3A 400A 402A and 404A to Effect A 406A. Effect 406A may include actions taken by the company, such as charging a late fee, or applying a payment to interest or principal of a loan. By linking characteristics 400A 402A 404A to an effect A 406A, the graph indicates that the characteristics may be a cause of the effect 406A.

FIG. 4B illustrates an exemplary graph of linked characteristics of historical transaction data generated by machine learning techniques of the root cause smart assistant. FIG. 4B includes characteristic 1B 400B, characteristic 2B 402B, and characteristic 3B 404B. The characteristics 400B 402B and 404B may include various characteristics of the historical transaction data such as date and time of the transaction, the monetary value of the transaction, and the parties to the transaction. The root cause smart assistant application links characteristics 1B, 2B, and 3B to effect B 406B. By way of example, FIG. 4B includes a different configuration than FIG. 4A by linking characteristic 1B and 3B. Using the machine learning techniques described in the description of FIG. 3, the application may identify differences between the graphs of FIG. 4A and FIG. 4B to determine the linked characteristics that are causes of the effect.

### Example Advantages of a Root Cause Smart Assistant

The root cause smart assistant is useful for businesses in reducing customer service staffing needs. For example, because the root cause smart assistant may answer more types of questions than other chatbots, users of the root cause smart assistant are less likely to need help from a human employee. Further, because the root cause smart assistant separates the logical steps of answering a question through a tree diagram (e.g. a “why” tree), the root cause smart assistant does not assume that a user is at fault or a service provider's records or actions are correct. The root cause smart assistant analyzes the question posed by the user logically without assuming fault of a party.

In some examples, the root cause smart assistant generates questions to answer itself, and based on the answers to its own questions, may then present a question to a user. In one such example, the user may pose a question such as “Why is my account balance lower than expected?” The root cause smart assistant may identify the account of the user and identify the transactions made by the account. The root cause smart assistant may identify a large withdrawal inconsistent with the user's past actions and generate a question requesting whether the user granted access to his or her account to another individual. The root cause smart assistant may then answer its own question by retrieving account details associated with the user account to determine whether the account is a joint account shared by multiple users and present a question to the user asking whether the joint users withdrew from the account.

In other examples, the root cause smart assistant application may proactively warn users when transactions are processed differently than past transactions. For example, a user may regularly make two mortgage payments to pay ahead on his or her mortgage. The application may identify a break in pattern of behavior of the user when characteristics of a current transaction deviate from characteristics of past user transactions. For example, when the user instead makes one payment with twice the mortgage payment amount, the application may identify a change in payment amount from the historical transaction data. Based on processing procedures of the company, the application may identify that excess money from a payment is paid on the principal of a loan and not towards the next loan payment. The application may notify the user of the difference in processing of the payment by sending a notification to the user, such as an SMS or email. In further examples, the application may communicate the user's change in behavior to the business processing the transaction to adjust the processing of the transaction.

### General Considerations

Although the subject matter has been described in language specific to structural features or methodological acts, it is to be understood that the subject matter of the appended claims is not necessarily limited to the specific features or acts described above. Rather, the specific features and acts described above are disclosed as examples.

Various operations of examples are provided herein. The order in which one or more or all of the operations are described should not be construed as to imply that these operations are necessarily order dependent. Alternative ordering will be appreciated based on this description. Further, not all operations may necessarily be present in each example provided herein.

As used in this application, “or” is intended to mean an inclusive “or” rather than an exclusive “or.” Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has,” “with,” or variants thereof are used in either the detailed description or the claims, such terms are intended to be inclusive in a manner similar to the term “comprising”.

Further, unless specified otherwise, “first,” “second,” or the like are not intended to imply a temporal aspect, a spatial aspect, or an ordering. Rather, such terms are merely used as identifiers, names, for features, elements, or items. For example, a first state and a second state generally correspond to state 1 and state 2 or two different or two identical states or the same state. Additionally, “comprising,” “comprises,” “including,” “includes,” or the like generally means comprising or including.

Although the disclosure has been shown and described with respect to one or more implementations, equivalent alterations and modifications will occur based on a reading and understanding of this specification and the drawings. The disclosure includes all such modifications and alterations and is limited only by the scope of the following claims.

1. A method comprising:
receiving from a first user an explanation request included in an input received via user interface;
determining, via natural language processing, that the explanation request includes a term associated with a current transaction;
determining characteristics of the current transaction based in part on current transaction data;
generating a first graph and a second graph using one or more of: correlation clustering and K-means clustering,
wherein the first graph includes (a) first characteristic nodes describing current characteristics of the current transaction data, (b) first effect nodes describing current processing actions for the current transaction data, and (c) first links among the first characteristic nodes and the first effect nodes, wherein the first links describe first connections of the first characteristic nodes with the first effect nodes,
wherein the second graph includes (a) second characteristic nodes describing historical characteristics of historical transaction data, (b) second effect nodes describing historical processing actions for the historical transaction data, and (c) second links among the second characteristic nodes and the second effect nodes, wherein the second links describe second connections of the second characteristic nodes with the second effect nodes;
comparing the first graph and the second graph, wherein the comparing is performed using one or more of: a neural network, a classifier a support-vector machine, a decision tree, or a Bayesian network, the comparing including:
determining that a particular first characteristic node in the first graph is linked to a particular first effect node in the first graph and that a particular second characteristic node in the second graph is linked to a particular second effect node in the second graph,
determining a first difference of the first graph from the second graph, the first difference determined between a current characteristic described by the particular first characteristic node in the first graph and a historical characteristic described by the particular second characteristic node in the second graph, and
determining a second difference of the first graph from the second graph, the second difference determined between a current processing action described by the particular first effect node in the first graph and a historical processing action described by the particular second effect node in the second graph;
determining, using machine learning, that the first difference between the current characteristic and the historical characteristic is associated with the second difference between the current processing action and the historical processing action;
generating a text description that includes a combination including: i) a shell template description, ii) information extracted from the current processing action described by the particular first effect node, and iii) additional information extracted from the historical processing action described by the particular second effect node; and
outputting the text description to a display device viewable by the first user.

2. The method of claim 1, wherein the current characteristics of the current transaction data and the historical characteristics of the historical transaction data comprise one or more of timing of transactions, monetary amounts of transactions, or transactors of transactions.

3. The method of claim 1, further comprising:
displaying, via a user interface, a diagram that displays the text description, wherein the diagram conveys steps taken by the machine learning in determining that the first difference of the at least one current characteristic from the at least one historical characteristic is associated with the second difference of the current processing action from the historical processing action.

4. The method of claim 1, further comprising:
requesting additional information associated with the current transaction from a database; and
receiving the additional information from the database and wherein the machine learning uses the additional information to determine one or more causes of the the first difference or the second difference between the first graph and the second graph.

5. The method of claim 1, wherein the machine learning calls an application programming interface (API) and searches one or more databases of prior transactions to determine one or more causes of the the first difference or the second difference between the first graph and the second graph.

6. The method of claim 1, further comprising:
generating a user profile based on the historical transaction data associated with the first user;
determining, based on the user profile, at least one processing difference in the current transaction;
notifying the first user of the at least one processing difference; and
processing the current transaction according to past transactions of the first user.

7. The method of claim 1, further comprising:
determining the current transaction is a loan payment; and
applying the loan payment to one or more of an outstanding balance, loan principal, or loan interest.

8. A non-transitory computer readable medium comprising instructions that when executed by one or more processors cause the one or more processors to:
receive from a first user an explanation request included in an input received via user interface;
determine, via natural language processing, that the explanation request includes a term associated with a current transaction;
determine characteristics of the current transaction based in part on current transaction data;
generate a first graph and a second graph using one or more of: correlation clustering and K-means clustering,
wherein the first graph includes (a) first characteristic nodes describing current characteristics of the current transaction data, (b) first effect nodes describing current processing actions for the current transaction data, and (c) first links among the first characteristic nodes and the first effect nodes, wherein the first links describe first connections of the first characteristic nodes with the first effect nodes,
wherein the second graph includes (a) second characteristic nodes describing historical characteristics of historical transaction data, (b) second effect nodes describing historical processing actions for the historical transaction data, and (c) second links among the second characteristic nodes and the second effect nodes, wherein the second links describe a second configuration-second connections of the second characteristic nodes with the second effect nodes;
compare the first graph and the second graph, wherein the comparing is performed using one or more of: a neural network, a classifier a support-vector machine, a decision tree, or a Bayesian network,
the comparing including:
determining that a particular first characteristic node in the first graph is linked to a particular first effect node in the first graph and that a particular second characteristic node in the second graph is linked to a particular second effect node in the second graph,
determining a first difference of the first graph from the second graph, the first difference determined between a current characteristic described by the particular first characteristic node in the first graph and a historical characteristic described by the particular second characteristic node in the second graph, and
determining a second difference of the first graph from the second graph, the second difference determined between a current processing action described by the particular first effect node in the first graph and a historical processing action described by the particular second effect node in the second graph;
determine, using machine learning, that the first difference between the current characteristic and the historical characteristic is associated with the second difference between the current processing action and the historical processing action;
generate a text description that includes a combination including: i) a shell template description, ii) information extracted from the current processing action described by the particular first effect node, and iii) additional information extracted from the historical processing action described by the particular second effect node; and
output the text description to a display device viewable by the first user.

9. The non-transitory computer readable medium of claim 8, wherein the current characteristics of the current transaction data and the historical characteristics of the historical transaction data comprise one or more of timing of transactions, monetary amounts of transactions, or transactors of transactions.

10. The non-transitory computer readable medium of claim 8, the instructions further causing the one or more processors to:
display, via a user interface, a diagram that displays the text description, wherein the diagram conveys steps taken by the machine learning in determining that the first difference of the at least one current characteristic from the at least one historical characteristic is associated with the second difference of the current processing action from the historical processing action.

11. The non-transitory computer readable medium of claim 8, the instructions further causing the one or more processors to:
request additional information associated with the current transaction from a database; and
receive the additional information from the database and wherein the machine learning uses the additional information to determine one or more causes of the the first difference or the second difference between the first graph and the second graph.

12. The non-transitory computer readable medium of claim 8, wherein the machine learning calls an application programming interface (API) and searches one or more databases of prior transactions to determine one or more causes of the the first difference or the second difference between the first graph and the second graph.

13. The non-transitory computer readable medium of claim 8, the instructions further causing the one or more processors to:
generate a user profile based on the historical transaction data associated with the first user;
determine, based on the user profile, at least one processing difference in the current transaction;
notify the first user of the at least one processing difference; and
process the current transaction according to past transactions of the first user.

14. The non-transitory computer readable medium of claim 8, the instructions further causing the one or more processors to:
determine the current transaction is a loan payment; and
apply the loan payment to one or more of an outstanding balance, loan principal, or loan interest.

15. A system comprising:
one or more processors configured to:
receive from a first user an explanation request included in an input received via user interface;
determine, via natural language processing, that the explanation request includes a term associated with a current transaction;
determine characteristics of the current transaction based in part on current transaction data;
generate a first graph and a second graph using one or more of: correlation clustering and K-means clustering,
wherein the first graph includes (a) first characteristic nodes describing current characteristics of the current transaction data, (b) first effect nodes describing current processing actions for the current transaction data, and (c) first links among the first characteristic nodes and the first effect nodes, wherein the first links describe first connections of the first characteristic nodes with the first effect nodes,
wherein the second graph includes (a) second characteristic nodes describing historical characteristics of historical transaction data, (b) second effect nodes describing historical processing actions for the historical transaction data, and (c) second links among the second characteristic nodes and the second effect nodes, wherein the second links describe second connections of the second characteristic nodes with the second effect nodes;
compare the first graph and the second graph, wherein the comparing is performed using one or more of: a neural network, a classifier a support-vector machine, a decision tree, or a Bayesian network,
the comparing including:
determining that a particular first characteristic node in the first graph is linked to a particular first effect node in the first graph and that a particular second characteristic node in the second graph is linked to a particular second effect node in the second graph,
determining a first difference of the first graph from the second graph, the first difference determined between a current characteristic described by the particular first characteristic node in the first graph and a historical characteristic described by the particular second characteristic node in the second graph, and
determining a second difference of the first graph from the second graph, the second difference determined between a current processing action described by the particular first effect node in the first graph and a historical processing action described by the particular second effect node in the second graph;
determine, using machine learning, that the first difference between the current characteristic and the historical characteristic is associated with the second difference between the current processing action and the historical processing action;
generate a text description that includes a combination including: i) a shell template description, ii) information extracted from the current processing action described by the particular first effect node, and iii) additional information extracted from the historical processing action described by the particular second effect node; and
output the text description to a display device viewable by the first user.

16. The system of claim 15, wherein the current characteristics of the current transaction data and the historical characteristics of the historical transaction data comprise one or more of timing of transactions, monetary amounts of transactions, or transactors of transactions.

17. The system of claim 15, the one or more processors further configured to:
display, via a user interface, a diagram that displays the text description, wherein the diagram conveys steps taken by the machine learning in determining that the first difference of the at least one current characteristic from the at least one historical characteristic is associated with the second difference of the current processing action from the historical processing action.

18. The system of claim 15, the one or more processors further configured to:
request additional information associated with the current transaction from a database; and
receive the additional information from the database and wherein the machine learning uses the additional information to determine one or more causes of the the first difference or the second difference between the first graph and the second graph.

19. The system of claim 15, wherein the machine learning calls an application programming interface (API) and searches one or more databases of prior transactions to determine one or more causes of the the first difference or the second difference between the first graph and the second graph.

20. The system of claim 15, the one or more processors further configured to:
generate a user profile based on the historical transaction data associated with the first user;
determine, based on the user profile, at least one processing difference in the current transaction;
notify the first user of the at least one processing difference; and
process the current transaction according to past transactions of the first user.
